(19) United States
(12) Patent Application Publication
(10) Pub. No.: US 2023/0276540 A1
(43) Pub. Date: Aug. 31, 2023

(54) HEATING SHEET, HEATING TUBE, AND ELECTRIC APPLIANCE

(71) Applicants: GUANGDONG MIDEA KITCHEN APPLIANCES MANUFACTURING CO., LTD., FOSHAN (CN); MIDEA GROUP CO., LTD., FOSHAN (CN)

(72) Inventors: Yanjun SUN, FOSHAN (CN); Yunlong LI, FOSHAN (CN); Xiangwei TANG, FOSHAN (CN)

(21) Appl. No.: 17/928,620

(22) PCT Filed: Oct. 18, 2021
(86) PCT No.: PCT/CN2021/124473

§ 371 Date: Nov. 30, 2022

(30) Foreign Application Priority Data
Oct. 30, 2020 (CN) 202011197840.3
Oct. 30, 2020 (CN) 202022484974.5

(51) Int. Cl. H05B 3/40; H05B 3/14

(52) U.S. Cl. CPC H05B 3/40; H05B 3/145; H05B 2203/003; H05B 2203/032

(57) ABSTRACT

Provided are a heating sheet, a heating tube, and an electric appliance. The heating sheet includes a graphite sheet substrate. The graphite sheet substrate includes a heating region and a buffer region. The buffer region is located at two ends of the graphite sheet substrate. The heating region is connected to the buffer region, and located on a side of the buffer region facing away from the two ends. The heating region includes a hollow zone. A duty ratio of the buffer region is greater than a duty ratio of the heating region. The heating sheet has advantages of good impact resistance and strong anti-fracture performance.

### CROSS-REFERENCES TO RELATED APPLICATIONS

The present disclosure is a national phase application of International Application No. PCT/CN2021/124473, filed on Oct. 18, 2021, which claims priorities to Chinese Patent Application No. 202011197840.3 and No. 202022484974.5, filed in the Chinese Patent Office on Oct. 30, 2020, the entireties of which are herein incorporated by reference.

### FIELD

The present disclosure relates to the field of electric appliance technologies, and more particularly, to a heating sheet, a heating tube, and an electric appliance.

### BACKGROUND

Since a heating tube is a core component of kitchen appliances such as electric ovens for baking and cooking, heating efficiency, response speed, and impulse current of the heating tube have become important indicators to measure performance of kitchen appliances. Conventional heating tubes have problems such as dispersed heating and slow response speed due to slow thermal conductivity of heating materials and low energy utilization of heating modes.

Therefore, conventional heating sheets, heating tubes, and electric appliances need to be improved.

### SUMMARY

The present disclosure is based on discovery of the following problems.

For a heating tube in a linear heating mode, radiation heat transfer is directed in a radial direction of the heating tube, resulting in problems such as dispersed heating and low energy utilization. In addition, it takes a conventional heating tube few tens of seconds or even longer to heat its surface to a highest temperature, which is a slow response speed. In addition, resistivity of heating wires of the heating tube changes with an increase in temperature, during which process a relatively high impulse current would be generated. A graphite heating tube was discovered to have characteristics of high heating efficiency, fast response speed, and low impulse current. However, a graphite sheet, which is quite brittle, is prone to fractures when subjected to mechanical shocks. During assembly of the heating tube in a conventional electric oven, the heating tube is in rigid contact with a wall surface the electric oven. When the electric oven is dropped, the heating tube is subjected to a stress transferred from the wall surface of the electric oven, resulting in a fracture of a heating sheet in a light-emitting tube.

The present disclosure aims to alleviate or solve at least one of the above problems to some extent.

In one embodiment of the present disclosure, a heating sheet is provided. The heating sheet includes a graphite sheet substrate. The graphite sheet substrate includes a buffer region and a heating region. The buffer region is located at two ends of the graphite sheet substrate. The heating region is connected to the buffer region and located on a side of the buffer region facing away from the two ends. The heating region includes a hollow zone. A duty ratio of the buffer region is greater than a duty ratio of the heating region. Thus, the heating sheet has advantages of good impact resistance and strong anti-fracture performance.

It should be noted that in the present disclosure, the term “duty ratio” is a ratio of an area of a part containing the graphite sheet substrate to a total area (a sum of the area of the part containing the graphite sheet substrate and an area of the hollow parts) of the graphite sheet substrate in this part in a predetermined region (e.g., the buffer region, the heating region). That is, an increase in the hollow parts leads to a decrease in the duty ratio. In a further embodiment, a total area of the graphite sheet substrate in the predetermined region may be an area of a zone enclosed by a connecting line along edges of the graphite sheet substrate extending in a second direction in this region.

Further, a length of each buffer region in an extending direction of the graphite sheet substrate ranges from 5 mm to 60 mm.

Further, the buffer region includes at least one of a first buffer region and a second buffer region. The first buffer region has a duty ratio of 1. The second buffer region has a duty ratio smaller than 1. The duty ratio of the second buffer region is greater than the duty ratio of the heating region.

Further, notches are defined in the second buffer region. Each of the notches extend from a side of the graphite sheet substrate towards a center of the graphite sheet substrate in an extending direction perpendicular to the extending direction of the graphite sheet substrate.

Each of the notches extend from an outer surface of the graphite sheet substrate towards the center of the graphite sheet substrate.

Further, the heating region includes heating units. Each of the heating units include a first portion, a second portion, a third portion, and a fourth portion that are connected end to end sequentially. The first portion and the third portion extend in a first direction, and the second portion and the fourth portion extend in a second direction. The first direction intersects with the second direction. The second direction is the extending direction of the graphite sheet substrate. The first direction is perpendicular to the second direction.

Further, a maximum dimension of the first portion and the second portion in the first direction is greater than a maximum depth of the notches. At least one of spacings between the notches is greater than a maximum dimension of the third portion and the fourth portion in the second direction. Each of the spacings between the notches is a distance between two adjacent notches, located on a same edge, of the notches.

A depth of each of the notches refers to a depth of the notch in the first direction. The disclosure “a maximum dimension of the first portion and the second portion in the first direction is greater than a maximum depth of the notches” means that a maximum value between a dimension in the first direction of the first portion in the heating region and a dimension in the first direction of the second portion in the heating region is greater than a maximum value of depths in the first direction of the notches in the second buffer region.

Each of the spacings between the notches is a distance between two adjacent notches, located on a same surface of the graphite sheet substrate, of the notches.

Similarly, for the notches defined in the second buffer region, distances between two adjacent notches located on a same surface of the graphite sheet substrate may be the same as or different from each other. The disclosure “at least one of spacings between the notches is greater than a maximum dimension of the third portion and the fourth portion in the second direction” means that at least one of the spacings between the notches is greater than a maximum value between a dimension of the third portion in the second direction and a dimension of the fourth portion in the second direction.

According to embodiments of the present disclosure, a maximum dimension between the first portion and the third portion in the first direction is greater than a maximum depth of the notches. At least one of spacings between the notches is greater than a maximum dimension between the second portion and the fourth portion in the second direction. Each of the spacings between the notches is a distance between two adjacent notches, located on a same edge, of the notches.

The disclosure “a maximum dimension of the first portion and the third portion in the first direction is greater than a maximum depth of the notches” means that a maximum value between a dimension of the first portion in the first direction and a dimension of the third portion in the first direction is greater than a maximum value of depths of the notches in the first direction.

The disclosure “at least one of spacings between the notches is greater than a maximum dimension of the second portion and the fourth portion in the second direction” means that at least one of the spacings between the notches is greater than a maximum value between a dimension of the second portion in the second direction and a dimension of the fourth portion in the second direction.

The heating region includes heating units. Each of the heating units includes a first portion, a second portion, a third portion, and a fourth portion, and has a recess. As can be seen from the above description, a maximum value of depths of the recesses in the heating units in the first direction is greater than a maximum value of depths of the notches in the second buffer region in the first direction.

Further, a length of each of the first buffer region and the second buffer region in the extending direction of the graphite sheet substrate ranges from 5 mm to 30 mm.

Further, the length of the second buffer region is smaller than the length of the first buffer region.

Further, the heating sheet satisfies at least one of the conditions: each of two buffer regions located at the two ends of the graphite sheet substrate is formed by the first buffer region or by the second buffer region; each of the two buffer regions located at the two ends of the graphite sheet substrate includes one first buffer region and one second buffer region; or one of the two buffer regions located at the two ends of the graphite sheet substrate is formed by one first buffer region, and the other one of the two buffer regions located at the two ends of the graphite sheet substrate is formed by one second buffer region.

In another embodiment of the present disclosure, a heating tube is provided. The heating tube includes the heating sheet as described above, an outer tube, a lead wire, and a connection terminal. The heating sheet is disposed in the outer tube. The heating sheet is connected to the connection terminal by the lead wire. As a result, the heating tube has all the features and advantages of the heating sheet described above, and thus details thereof will be omitted. In general, the heating tube has advantages such as fast response speed, high heating efficiency, and low impulse current.

In another embodiment of the present disclosure, an electric appliance is provided. The electric appliance includes the heating tube as described above. As a result, the electric appliance has all the features and advantages of the heating tube described above, and thus details thereof will be omitted. In general, the electric appliance has advantages such as satisfying heating performance and good impact resistance.

Further, the electric appliance includes an electric oven, a microwave oven, or a steam oven.

### BRIEF DESCRIPTION OF THE DRAWINGS

The above and/or additional embodiments of the present disclosure will become more apparent and more understandable from the following description of embodiments in conjunction with the accompanying drawings.

FIG. 1 illustrates a schematic structural view of a heating sheet according to an embodiment of the present disclosure.

FIG. 2 illustrates a schematic view of an assembly relationship of a heating tube according to an embodiment of the present disclosure.

FIG. 3 illustrates a schematic view of a force applied to a heating tube according to an embodiment of the present disclosure.

FIG. 4 illustrates a schematic view of an internal force of a heating tube according to an embodiment of the present disclosure.

FIG. 5 illustrates a schematic structural view of a heating unit according to an embodiment of the present disclosure.

FIG. 6 illustrates a schematic structural view of a heating sheet according to another embodiment of the present disclosure.

FIG. 7 illustrates a schematic structural view of a heating sheet according to yet another embodiment of the present disclosure.

FIG. 8 illustrates a schematic structural view of a heating tube according to an embodiment of the present disclosure.

Reference numerals of the accompanying drawings:
100: graphite sheet substrate; 110: heating region; 120: buffer region; 121: first buffer region; 122: second buffer region; 10: heating unit; 11: first portion; 12: second portion; 13: third portion; 14: fourth portion; 200: outer tube; 300: lead wire; 400: connection terminal; 1000: heating tube.

### DETAILED DESCRIPTION OF THE DISCLOSURE

Embodiments of the present disclosure will be described in detail below with reference to examples thereof as illustrated in the accompanying drawings, throughout which same or similar elements, or elements having same or similar functions, are denoted by same or similar reference numerals. The embodiments described below with reference to the drawings are illustrative only, and are intended to explain, rather than limiting, the present disclosure.

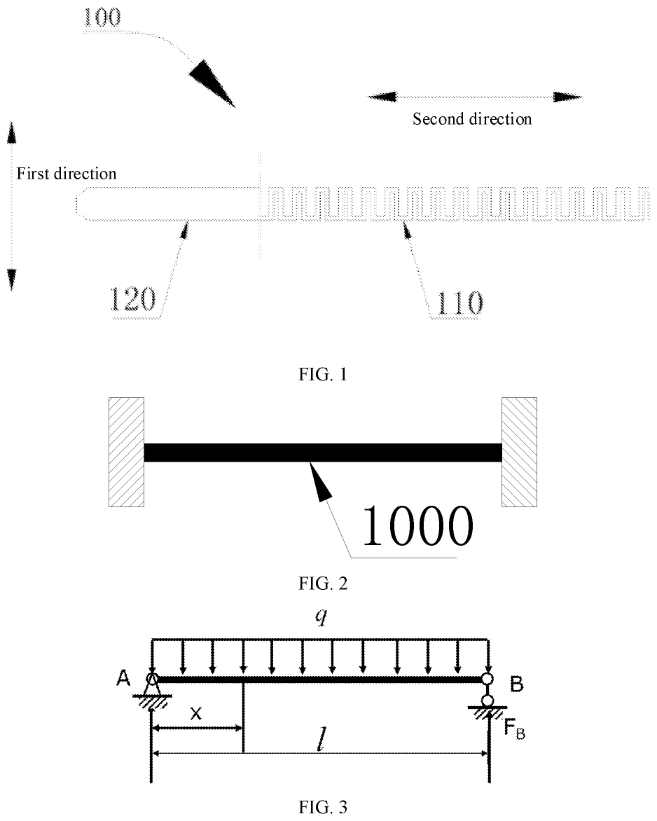

In one embodiment of the present disclosure, a heating sheet is provided. The heating sheet includes a graphite sheet substrate. Referring to FIG. 1, a graphite sheet substrate 100 includes a heating region 110 and a buffer region 120. The buffer region 120 is located at two ends of the graphite sheet substrate 100. The two ends are located on two opposite sides of the graphite sheet substrate 100 (only one end is illustrated in FIG. 1). The heating region 110 is connected to the buffer region 120, and located on a side of the buffer region 120 facing away from the two ends. The heating region 110 includes a hollow zone. A duty ratio of the buffer region 120 is greater than that of the heating region 110. The graphite sheet substrate, which is quite brittle, is prone to fractures when subjected to an external force. In the present disclosure, by providing the buffer region, an impact of the external force on the heating sheet can be attenuated, which effectively avoids an undesirable phenomenon of fractures of the heating sheet due to the impact of the external force.

In the present disclosure, the term “duty ratio” is a ratio of an area of a part containing the graphite sheet substrate to a total area (a sum of the area of the part containing the graphite sheet substrate and an area of the hollow parts) of the graphite sheet substrate in this part in a predetermined region (e.g., the buffer region, the heating region). That is, an increase in the hollow parts leads to a decrease in the duty ratio. In a further embodiment, a total area of the graphite sheet substrate in the predetermined region may be an area of a zone enclosed by a connecting line along edges of the graphite sheet substrate extending in a second direction in this region.

For ease of understanding, a brief explanation of the principle by which the heating sheet can achieve the advantageous effects described above will be described below.

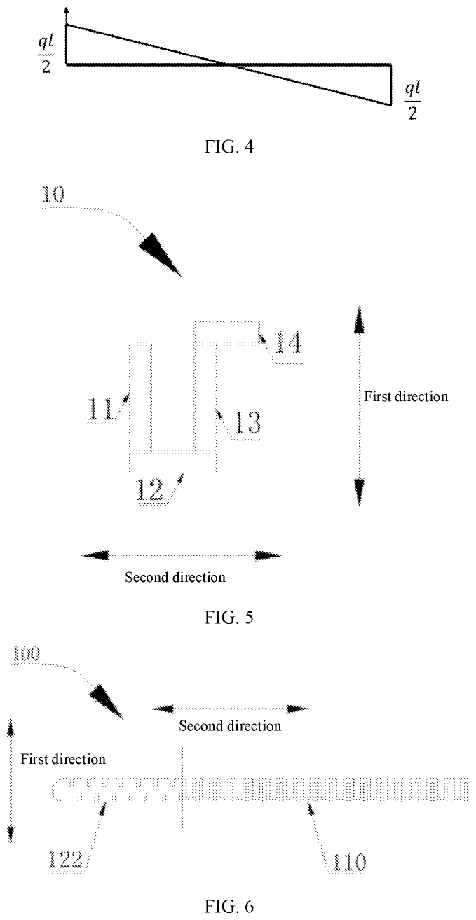

Taking an electric oven including a heating tube as an example, with reference to FIG. 2, the heating tube 1000 is in rigid contact with a wall surface of the electric oven during assembly of the heating tube 1000 into the electric oven. That is, an assembly relationship between the heating tube 1000 and the wall surface of the electric oven may be simplified as a fixed beam structure. A force analysis of the heating tube is made with reference to FIG. 3. When the electric oven is dropped, the heating tube is subjected to a load transferred from the wall surface of the electric oven. The load may be considered to be uniformly distributed on the heating tube. Therefore, any part of the heating tube, e.g., a part of a length x from an end of the heating tube, is subjected to a force of:

$$Fs = \frac{ql}{2} - qx ,$$

where q represents the load transferred from the wall surface of the electric oven to which the heating tube is subjected when the electric oven is dropped, and/represents a total length of the heating tube. Referring to FIG. 4, when the heating tube is dropped, two ends of the heating tube are subjected to a force of

$$\frac{ql}{2} ,$$

and a middle position of the heating tube, i.e., a position where distances x from the two ends of the heating tube is

$$\frac{l}{2} ,$$

is subjected to a force of 0. Referring to FIG. 5, since the heating sheet in the heating tube needs to be profiled to form a bent heating unit 10 for a purpose of improving heating efficiency of the heating sheet. That is, partial regions of the heating sheet, e.g., a second portion 12 and a fourth portion 14, are narrow, and thus are subjected to a relatively great tangential stress due to their small force-bearing areas. From the above example diagram of an internal force, it can be seen that tangential stresses at the two ends of the heating tube are relatively large, and it is easy to reach a tangential stress threshold of a material of the heating sheet, which makes the heating sheet fracture. In the present disclosure, a heating sheet having a buffer structure is provided. By means of providing the buffer structure having partially-wide regions at two ends of the heating sheet, tangential stresses on the ends of the heating sheet are reduced to improve the impact resistance of the heating sheet, which avoids an undesirable phenomenon of malfunction of heating of the heating sheet caused by fractures of the heating sheet in the heating tube during a drop of the electric oven.

In the present disclosure, since the heating region has a hollow structure, it is conceivable that a graphite structure in the heating region is partially hollow and occupied by “blanks”.

According to some embodiments of the present disclosure, the buffer region is used to improve impact and fracture resistance of the heating sheet. A length of the buffer region is not limited herein. For example, a length of the buffer region in an extending direction of the graphite sheet substrate may range from 5 mm to 60 mm. When the length of the buffer region is smaller than 5 mm, the length of the buffer region is too short to effectively improve the impact resistance of the heating sheet. When the length of the buffer region is greater than 60 mm, the graphite sheet substrate is commonly in a form of a large continuous area due to a high duty ratio of the buffer region, and thus provides poor heating performance. When the length of the buffer region is too long, the entire heating sheet has poor heating performance, which cannot satisfy daily use requirements of the heating tube.

According to some embodiments of the present disclosure, referring to FIG. 1, impact resistance of the buffer region increases as the duty ratio of the buffer region increases. For example, the duty ratio of the buffer region 120 may be 1. That is, no profiling processing is performed on the graphite sheet substrate in the buffer region, and no hollow zone is formed. Therefore, the graphite sheet substrate in the buffer region has good impact resistance, which helps to mitigate damages to the heating sheet during the drop of the heating sheet.

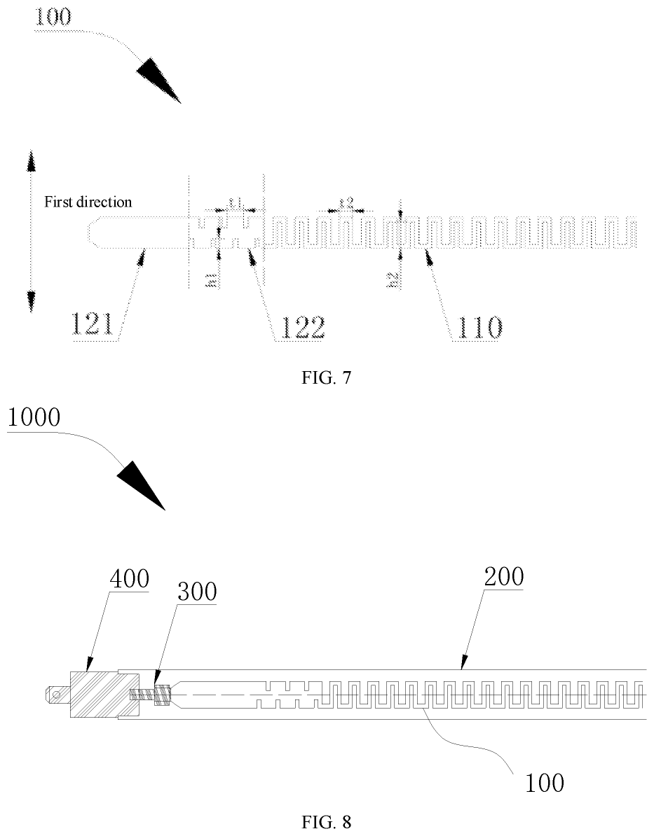

According to some embodiments of the present disclosure, the buffer region of the heating sheet is not limited in structure. The buffer region may include at least one of a first buffer region or the second buffer region. In some embodiments, referring to FIG. 7, a duty ratio of a first buffer region 121 is 1, and a duty ratio of a second buffer region 122 is smaller than 1 and greater than a duty ratio of the heating region 110. Therefore, the first buffer region 121 has no hollow structure to better attenuate a stress, while the second buffer region 122 partially has a hollow structure to attenuate a stress from the heating region 110, and provide satisfying heating performance. Thus, it is possible to effectively improve heating performance of the heating tube.

According to some embodiments of the present disclosure, distributions of the first buffer region 121 and the second buffer region 122 on the graphite sheet substrate 100 are not limited herein. For example, both two buffer regions 120 at two ends of the graphite sheet substrate 100 may be formed by the first buffer region 121 or by the second buffer region 122. That is, both the two buffer regions 120 at two ends of the graphite sheet substrate 100 may be the first buffer regions 121 or the second buffer regions 122. For example, one of the two buffer regions 120 at two ends of the graphite sheet substrate 100 may be formed by one first buffer region 121, and the other may be formed by one second buffer region 122.

According to some embodiments of the present disclosure, referring to FIG. 6, the buffer region 120 may include only the second buffer region 122. The buffer region 120 may also include only the first buffer region 121 (not illustrated).

According to some embodiments of the present disclosure, referring to FIG. 7, the buffer region 120 may include both the first buffer region 121 and the second buffer region 122. When the buffer region 120 includes both the first buffer region 121 and the second buffer region 122, the first buffer region 121 and the second buffer region 122 may be arranged at only one end of the heating region 110, or at two ends of the heating region 110, respectively. For example, when the first buffer region 121 is first arranged at one end of the heating region 110 and then the second buffer region 122 is to be arranged, or when the second buffer region 122 is first arranged at one end of the heating region 110 and then the first buffer region 122 is to be arranged, a buffer region different from the first buffer region 121 and/or the second buffer region 122 may be arranged at the other end of the heating region 110. The structure of the buffer region at the other end is not limited in the present disclosure, as long as the buffer region at the other end has a buffer function. The other end of the heating region 110 may also be provided with only the first buffer region 121, only the second buffer region 122, or both the first buffer region 121 and the second buffer region 122. In addition, an order of arranging the first buffer region 121 and the second buffer region 122 on the other end of the heating region 110 is not limited in the present disclosure.

According to some embodiments of the present disclosure, the second buffer region 122 may have notches. Each of the notches extends from a side of the graphite sheet substrate 100 towards a center of the graphite sheet substrate 100 in an extending direction perpendicular to the extending direction of the graphite sheet substrate 100. When the second buffer region 122 has the above-mentioned structure, the second buffer region 122 can provide good impact resistance for a reason that the second buffer region 122 is partially wider than the heating region 110. Due to its bending structure, the second buffer region 122 can provide good heating performance.

The heating region 110 includes heating units 10 connected in series or in parallel. The heating units 10 connected in series will be described below as an example.

According to some embodiments of the present disclosure, referring to FIG. 5, the heating unit 10 is not limited in structure. For example, the heating unit 10 may include a first portion 11, a second portion 12, a third portion 13, and a fourth portion 14 that are connected end to end sequentially. The first portion 11 and the third portion 13 extend in a first direction. The second portion 12 and the fourth portion 14 extend in a second direction. The first direction intersects with the second direction. The second direction is the extending direction of the graphite sheet substrate 100. The first direction is perpendicular to the second direction. When the heating unit 10 has the above-mentioned structure, heat generation and heat dissipation of the heating sheet can be facilitated to provide the heating sheet with satisfying heating performance.

According to some embodiments of the present disclosure, the first portion 11, the second portion 12, the third portion 13, and the fourth portion 14 are not limited in dimension. For example, a maximum dimension of the first portion 11 and the second portion 12 in the first direction may be greater than a maximum depth of the plurality of notches; at least one of spacings between the notches is greater than a maximum dimension of the third portion 13 and the fourth portion 14 in the second direction; and each of the spacings between the notches is a distance between two adjacent notches, located on a same edge, of the notches.

According to embodiments of the present disclosure, the description “a maximum dimension of the first portion 11 and the second portion 12 in the first direction” means a maximum value between a dimension of the first portion 11 in the first direction and a dimension of the second portion 12 in the first direction.

The description “a maximum dimension of the third portion 13 and the fourth portion 14 in the second direction” means a maximum value between a dimension of the third portion 13 in the second direction and a dimension of the fourth portion 14 in the second direction.

According to some embodiments of the present disclosure, referring to FIG. 7, depths of the notches may be same to or different from each other. When the depths of the notches are different from each other, a maximum dimension h2 of the first portion 11 and the third portion 13 in the first direction may be greater than a maximum depth h1 of the notches to ensure that the duty ratio of the buffer region is greater than that of the heating region.

The description “a maximum dimension of the first portion 11 and the third portion 13 in the first direction” means a maximum value between a dimension of the first portion 11 in the first direction and a dimension of the third portion 13 in the first direction.

Similarly, referring to FIG. 7, among the notches located on a surface at a same side of the graphite sheet substrate 100, spacings between every two adjacent notches may be same to or different from each other, and a length of the second portion 12 in the second direction may be same to or different from a length of the fourth portion 14 in the second direction. When the spacings between every two adjacent notches are different from each other, a length t2 of each of the second portion 12 and the fourth portion 14 in the second direction may be smaller than a spacing t1 between two adjacent notches to ensure that the duty ratio of the buffer region is greater than that of the heating region.

According to some embodiments of the present disclosure, when only the first buffer region 121 is arranged at the two ends of the heating region 110, the first buffer region 121 is not limited in length. For example, the length of the first buffer region 121 in the extending direction of the graphite sheet substrate 100 may range from 5 mm to 60 mm. When the length of the first buffer region 121 falls within the above range, the buffer region 120 cannot only provide good impact resistance, but also mitigate an effect of the arrangement of the buffer region 120 on the heating performance of the heating sheet.

According to some embodiments of the present disclosure, when only the second buffer region 122 is arranged at the two ends of the heating region 110, the second buffer region 122 is not limited in length. For example, the length of the second buffer region 122 in the extending direction of the graphite sheet substrate 100 may range from 5 mm to 60 mm When the length of the second buffer region 122 falls within the above range, the buffer region 120 cannot only provide good impact resistance, but also mitigate an effect of setting of the buffer region 120 on the heating performance of the heating sheet.

According to some embodiments of the present disclosure, when the first buffer region 121 and the second buffer region 122 are arranged at the two ends of the heating region 110, respectively, the first buffer region 121 and the second buffer region 122 are not limited in length. For example, the length of each of the first buffer region 121 and the second buffer region 122 in the extending direction of the graphite sheet substrate 100 may range from 5 mm to 30 mm. In some embodiments, the length of the first buffer region 121 may be 20 mm, and the length of the second buffer region 122 may be 15 mm. When the length of the first buffer region 121 and the length of the second buffer region 122 fall within the above range, the buffer region 120 cannot only provide good impact resistance, but also mitigate an effect of the arrangement of the buffer region 120 on the heating performance of the heating sheet.

According to some embodiments of the present disclosure, a relationship between the length of the first buffer region 121 and the length of the second buffer region 122 is not limited. For example, the length of the second buffer region 122 may be smaller than the length of the first buffer region 121. In this way, the impact resistance of the heating sheet can be further improved.

In another embodiment of the present disclosure, referring to FIG. 8, a heating tube 1000 is provided according to some embodiments of the present disclosure. The heating tube 1000 includes the heating sheet as described above, an outer tube 200, a lead wire 300, and a connection terminal 400. The heating sheet is disposed in the outer tube 200. The heating sheet is connected to the connection terminal 400 by the lead wire 300. As a result, the heating tube has all the features and advantages of the heating sheet described above, and thus details thereof will be omitted herein. In general, the heating tube has advantages such as fast response speed, high heating efficiency, and low impulse current.

In another embodiment of the present disclosure, an electric appliance is provided. The electric appliance includes the heating tube as described above. As a result, the electric appliance has all the features and advantages of the heating tube described above, and thus details thereof will be omitted herein. In general, the electric appliance has advantages such as satisfying heating performance and good impact resistance.

According to some embodiments of the present disclosure, types of the electric appliance are not limited. For example, the electric appliance may be an electric oven, a microwave oven, or a steam oven.

In the description of the present disclosure, the orientation or position relationship indicated by terms “upper”, “lower”, etc., is based on the orientation or position relationship shown in the drawings, and is only for the convenience of describing the present disclosure, rather than requiring that the present disclosure must be constructed and operated in a specific orientation, and therefore cannot be understood as a limitation on the present disclosure. In the description of the present disclosure, descriptions with reference to terms “one embodiment”, “another embodiment”, etc., mean that specific features, structure, materials or characteristics described in conjunction with the embodiment are included in at least one embodiment of the present disclosure. In this specification, the schematic representations of the above terms do not necessarily refer to the same embodiment or example. Moreover, the described specific features, structures, materials or characteristics may be combined in any one or more embodiments or examples in a suitable manner. In addition, the different embodiments or examples and the features of the different embodiments or examples described in this specification may be combined without contradicting each other. Further, it should be noted that in this specification, the terms “first” and “second” are only used for descriptive purposes, and cannot be understood as indicating or implying relative importance or implicitly indicating the number of indicated embodiments.

Although the embodiments of the present disclosure have been shown and described above, it should be understood that the above-mentioned embodiments are exemplary and should not be construed as limiting the present disclosure. Changes, modifications, substitutions, and modifications to the above-mentioned embodiments may be within the scope of the present disclosure.

1. A heating sheet, comprising
a graphite sheet substrate, wherein the graphite sheet substrate comprises:
a buffer region located at a first and a second end of the graphite sheet substrate; and
a heating region connected to the buffer region and located on a side of the buffer region facing away from the first end and the second end, wherein:
the heating region comprises a hollow zone; and
a duty ratio of the buffer region is greater than a duty ratio of the heating region.

2. The heating sheet according to claim 1, wherein, a length of the buffer region in an extending direction of the graphite sheet substrate ranges from 5 mm to 60 mm.

3. The heating sheet according to claim 2, wherein the buffer region comprises at least one of a first buffer region and a second buffer region, the first buffer region having a duty ratio of 1, and the second buffer region having a greater duty ratio than the heating region.

4. The heating sheet according to claim 3, wherein:
a plurality of notches is defined in the second buffer region;
each of the plurality of notches extends from a side of the graphite sheet substrate towards a center of the graphite sheet substrate in an extending direction perpendicular to the extending direction of the graphite sheet substrate.

5. The heating sheet according to claim 4, wherein the heating region comprises a plurality of heating units, each of the plurality of heating units comprising a first portion, a second portion, a third portion, and a fourth portion that are connected end to end sequentially, wherein:
the first portion and the third portion extend in a first direction;
the second portion and the fourth portion extend in a second direction;
the first direction intersects with the second direction;
the second direction is the extending direction of the graphite sheet substrate; and
the first direction is perpendicular to the second direction.

6. The heating sheet according to claim 5, wherein:
a maximum dimension of the first portion and the second portion in the first direction is greater than a maximum depth of the plurality of notches; and
the at least one of spacings between the plurality of notches is greater than a maximum dimension of the third portion and the fourth portion in the second direction, each of the at least one of spacings between the plurality of notches being a distance between two adjacent notches, located on a same side, of the plurality of notches.

7. The heating sheet according to claim 5, wherein:
a maximum dimension of the first portion and the third portion in the first direction is greater than a maximum depth of the plurality of notches; and
the at least one of spacings between the plurality of notches is greater than a maximum dimension of the second portion and the fourth portion in the second direction, each of the at least one of spacings between the plurality of notches being a distance between two adjacent notches, located on a same side, of the plurality of notches.

8. The heating sheet according to claim 3, wherein:
a length of each of the first buffer region and the second buffer region in the extending direction of the graphite sheet substrate ranges from 5 mm to 30 mm.

9. The heating sheet according to claim 8, wherein the length of the second buffer region is smaller than the length of the first buffer region.

10. The heating sheet according to claim 3, wherein each of two buffer regions located at the first and the second end of the graphite sheet substrate is formed by the first buffer region or by the second buffer region.

11. The heating sheet according to claim 3, wherein each of two buffer regions located at the first and the second end of the graphite sheet substrate comprises one first buffer region and one second buffer region.

12. The heating sheet according to claim 3, wherein a first of two buffer regions located at the first and the second end of the graphite sheet substrate is formed by one first buffer region, and a second of the two buffer regions located at the first and the second end of graphite sheet substrate is formed by one second buffer region.

13. A heating tube, comprising:
a heating sheet comprising a graphite sheet substrate, the graphite sheet substrate comprising:
a buffer region located at first and the second end of the graphite sheet substrate; and
a heating region connected to the buffer region and located on a side of the buffer region facing away from the first and second end, wherein the heating region comprises a hollow zone, and wherein a duty ratio of the buffer region is greater than a duty ratio of the heating region;
an outer tube, the heating sheet being disposed in the outer tube;
a lead wire; and
a connection terminal,
wherein the heating sheet is connected to the connection terminal by the lead wire.

14. The heating tube according to claim 13, wherein, a length of the buffer region in an extending direction of the graphite sheet substrate ranges from 5 mm to 60 mm.

15. The heating tube according to claim 14, wherein the buffer region comprises at least one of a first buffer region and a second buffer region, the first buffer region having a duty ratio of 1, and the second buffer region having a greater duty ratio than the heating region.

16. The heating tube according to claim 15, wherein:
a plurality of notches is defined in the second buffer region;
each of the plurality of notches extends from a side of the graphite sheet substrate towards a center of the graphite sheet substrate in an extending direction perpendicular to the extending direction of the graphite sheet substrate.

17. The heating tube according to claim 16, wherein the heating region comprises a plurality of heating units, each of the plurality of heating units comprising a first portion, a second portion, a third portion, and a fourth portion that are connected end to end sequentially, wherein:
the first portion and the third portion extend in a first direction;
the second portion and the fourth portion extend in a second direction;
the second direction is the extending direction of the graphite sheet substrate; and
the first direction is perpendicular to the second direction.

18. The heating tube according to claim 17, wherein:
a maximum dimension of the first portion and the second portion in the first direction is greater than a maximum depth of the plurality of notches; and
the at least one of spacings between the plurality of notches is greater than a maximum dimension of the third portion and the fourth portion in the second direction, each of the at least one of spacings between the plurality of notches being a distance between two adjacent notches, located on a same side, of the plurality of notches.

19. An electric appliance, comprising a heating tube, the heating tub comprising:
a heating sheet comprising a graphite sheet substrate, the graphite sheet substrate comprising:
a buffer region located at a first and a second end of the graphite sheet substrate; and
a heating region connected to the buffer region and located on a side of the buffer region facing away from a first end and a second end, wherein the heating region comprises a hollow zone, and wherein a duty ratio of the buffer region is greater than a duty ratio of the heating region;
an outer tube, the heating sheet being disposed in the outer tube;
a lead wire; and
a connection terminal,
wherein the heating sheet is connected to the connection terminal by the lead wire.

20. The electric appliance according to claim 19, comprising an electric oven, a microwave oven, or a steam oven.
